(19) United States
(12) Patent Application Publication
(10) Pub. No.: US 2010/0259655 A1
(43) Pub. Date: Oct. 14, 2010

(54) IMAGING DEVICE

(75) Inventor: Jun Takayama, Tokyo (JP)

Correspondence Address: LUCAS & MERCANTI, LLP, 475 PARK AVENUE SOUTH, 15TH FLOOR, NEW YORK, NY, 10016, US

(73) Assignee: KONICA MINOLTA HOLDINGS, INC., Tokyo (JP)

(21) Appl. No.: 12/739,987

(22) PCT Filed: Oct. 10, 2008
(86) PCT No.: PCT/JP2008/068463

§ 371 Date: Apr. 27, 2010

(30) Foreign Application Priority Data
Nov. 1, 2007 (JP) 2007285200

(51) Int. Cl. H04N 5/225

(52) U.S. Cl. 348/262; 348/E05.031

(57) ABSTRACT

A high-precision imaging device implemented by minimizing the number of members interposed between imaging surfaces of imaging elements and minimizing the cumulative error between the imaging surfaces of the imaging elements. The imaging device comprises imaging elements each including pixels having a photoelectric conversion function and a support in which the imaging elements are mounted. The imaging elements are positioned in respective optical axis directions by abutting on the support.

### FIELD OF TECHNOLOGY

The present invention relates to an imaging device that includes a plurality of imaging elements.

### BACKGROUND OF ART

With a conventional stereo camera, cameras using imaging elements are generally fixed to a support (see Patent Documents 1 to 3). Patent Document 4 proposes an imaging device in which a board on which imaging elements are mounted is abutted on a support so that the board is installed thereto.

Patent Document 1: Japanese Patent Application Publication No. Hei 11 (1999)-237684

Patent Document 2: Japanese Patent Application Publication No. Hei 11 (1999)-239288

Patent Document 3: Japanese Patent Application Publication No. 2001-88623

Patent Document 4: Japanese Patent Application Publication No. 2001-242521

### DISCLOSURE OF THE INVENTION

### Problems to be Solved by the Invention

In a three-dimensional imaging device that uses a plurality of cameras, such as a stereo camera, precision of a measured distance is determined by the installation error of a plurality of installed imaging elements, so the positional relation among the imaging surfaces of the plurality of imaging elements is important. The installation error is also determined by cumulative machining precision and cumulative installation precision of members disposed among the imaging elements; the cumulative installation precision largely depends on the number of installation positions. Accordingly, the fewer the number of members disposed among the imaging elements is, the higher the precision is.

Although the cumulative error can also be reduced by increasing the precision of each member, when machining precision is increased, the machining cost of each member is generally increased accordingly. When machining precision remains the same, the cumulative error becomes small as the number of members is lessened.

In Patent Document 4 as well, there are a board and a package for storing imaging elements between imaging elements, besides a supporting member. Cumulative error viewed from the imaging surface includes imaging element thickness error, package thickness error, package installation error, installation error between the package and the board, board shape error, and installation error in installation of the board to the support.

The present invention addresses the above problems in the prior art with the object of providing an imaging device with high precision that is achieved by minimizing the number of members interposed among the imaging surfaces of a plurality of imaging elements and by minimizing cumulative error among the imaging surfaces of the plurality of imaging elements.

### Means for Solving the Problems

To achieve the above object, the imaging device described in claim 1 is characterized in that it includes a plurality of imaging elements, each of which has a plurality of pixels, each of which has a photoelectric conversion function, and also includes a support to which the plurality of imaging elements are installed; each of the plurality of imaging elements is positioned in an optical axial direction by being abutted on the support.

According to this imaging device, each of the plurality of imaging elements is positioned in the axial direction by being abutted on the common support, so the number of members interposed among the imaging surfaces of the plurality of imaging elements can be minimized and the cumulative error among the imaging surfaces of the plurality of imaging elements can be minimized, making the imaging device highly precise.

The imaging device described in claim 2 is characterized in that, in the invention described in claim 1, the imaging device has an optical unit having an optical system that forms an image on the imaging elements, a supporting member that abuts on the imaging elements is formed on part of the optical system, and the optical unit is positioned in the optical axial direction by having the supporting member abutted on the imaging elements. Accordingly, the inclination of the optical axis of the optical unit can be minimized.

The imaging device described in claim 3 is characterized in that, in the invention described in claim 1, the imaging device has an optical unit having an optical system that forms an image on the imaging elements, a supporting member that abuts on the support is formed on part of the optical system, and the optical unit is positioned in an optical axial direction by having the supporting member abutted on the support. Accordingly, the inclination of the optical axis of the optical unit can be minimized.

The imaging device described in claim 4 is characterized in that, in the invention described in any one of claims 1 to 3, in each of the plurality of imaging elements, an area other than a photoelectric conversion area formed with the plurality of pixels abuts on the support.

The imaging device described in claim 5 is characterized in that, in the invention described in any one of claims 1 to 3, in each of the plurality of imaging elements, a pixel area that is not used for an image in a photoelectric conversion area formed with the plurality of pixels abuts on the support.

The imaging device described in claim 6 is characterized in that it includes a plurality of imaging units, each of which includes an imaging element having a plurality of pixels, each of which has a photoelectric conversion function, and an optical member that abuts on the imaging element, and also includes a support to which the plurality of imaging elements are installed; each of the plurality of imaging units is positioned in an optical axial direction by having the optical member of the imaging unit abutted on the support and is installed to the support.

According to this imaging device, the plurality of imaging units are positioned in their relevant axial directions by having the optical member that abuts on the imaging element abutted on the support, so the number of members interposed among the imaging surfaces of the plurality of imaging elements can be minimized and the cumulative error among the imaging surfaces of the plurality of imaging elements can be minimized, making the imaging device highly precise.

The imaging device described in claim 7 is characterized in that, in the invention described in claim 6, the imaging device has an optical unit having an optical system in which an image is formed on the imaging elements, a supporting member that abuts on the optical member is formed on part of the optical system, and the optical unit is positioned in the optical axial direction by having the supporting member abutted on the optical member. Accordingly, the inclination of the optical axis of the optical unit can be minimized.

The imaging device described in claim 8 is characterized in that it has a plurality of camera units, each of which has an imaging element having a plurality of pixels, each of which has a photoelectric conversion function, and an optical unit having an optical system in which an image is formed on the imaging element, a supporting member that abuts on the imaging elements being formed on part of the optical system, the optical unit being positioned in an optical axial direction by having the supporting member abutted on the imaging element, and also includes a support to which the plurality of camera units are installed; each of the plurality of camera units is positioned in the optical axial direction and installed to the support by being abutted on the support.

According to this imaging device, the optical unit is positioned in the axial direction by having the supporting member, formed in part of the optical system of the optical unit of each camera unit, abutted on the imaging element, so the number of members interposed among the imaging surfaces of the plurality of imaging elements can be minimized and the cumulative error among the imaging surfaces of the plurality of imaging elements can be minimized, making the imaging device highly precise. In addition, since the optical unit is positioned in the optical axial direction by having the supporting member of the optical unit abutted on the imaging element, the inclination of the optical axis of the optical unit can be minimized.

### EFFECT OF THE INVENTION

According to the present invention, a highly precise imaging device can be achieved by minimizing the number of members interposed among the imaging surfaces of a plurality of imaging elements and minimizing cumulative error among the imaging surfaces of the plurality of imaging elements.

### BRIEF DESCRIPTION OF THE DRAWINGS

FIG. 1 is a cross sectional view of the main parts of an imaging device according to a first embodiment.

FIG. 2 is an exploded cross sectional view of the main parts, which illustrates exploded parts of the imaging device in FIG. 1.

FIG. 3 is a cross sectional view of the main parts, which illustrates a first variation of the imaging device in FIGS. 1 and 2.

FIG. 4 is a cross sectional view of the main parts, which illustrates a second variation of the imaging device in FIGS. 1 and 2.

FIG. 5 is a cross sectional view of the main parts of an imaging device according to a second embodiment.

FIG. 6 is a cross sectional view of the main parts, which illustrates a first variation of the imaging device in FIG. 5.

FIG. 7 is a cross sectional view of the main parts, which illustrates a second variation of the imaging device in FIG. 5.

FIG. 8 is an exploded cross sectional view of the main parts, which illustrates exploded parts of the imaging device in FIG. 7.

FIG. 9 is a cross sectional view of the main parts, which illustrates a third variation of the imaging device in FIG. 5.

FIG. 10 is a cross sectional view of a side, which illustrates a variation of the imaging unit in FIGS. 5 to 9.

FIG. 11 is a cross sectional view of the main parts of an imaging device according to a third embodiment.

### EXPLANATION OF NUMERALS

1 Support
2, 3 Installation hole
4, 5 Projection
4a, 5a Step
7, 8, 7A Step
10, 10A, 10B Imaging device
11, 12 Imaging element
11a, 12a Imaging surface
11b, 12b Spacer
20 Optical unit
21, 22 Lens
23 Supporting member
24 Lens frame member
28, 28A Board
29, 29A, 29B Sealing member
30, 30A, 30B, 30C, 40 Imaging device
31, 32 Imaging unit
33 Optical member
41, 42 Camera unit
43 Camera frame member
P1, P2 Optical axis

### BEST MODE FOR CARRYING OUT THE INVENTION

The best mode for carrying out the invention will be described with reference to the drawings.

### First Embodiment

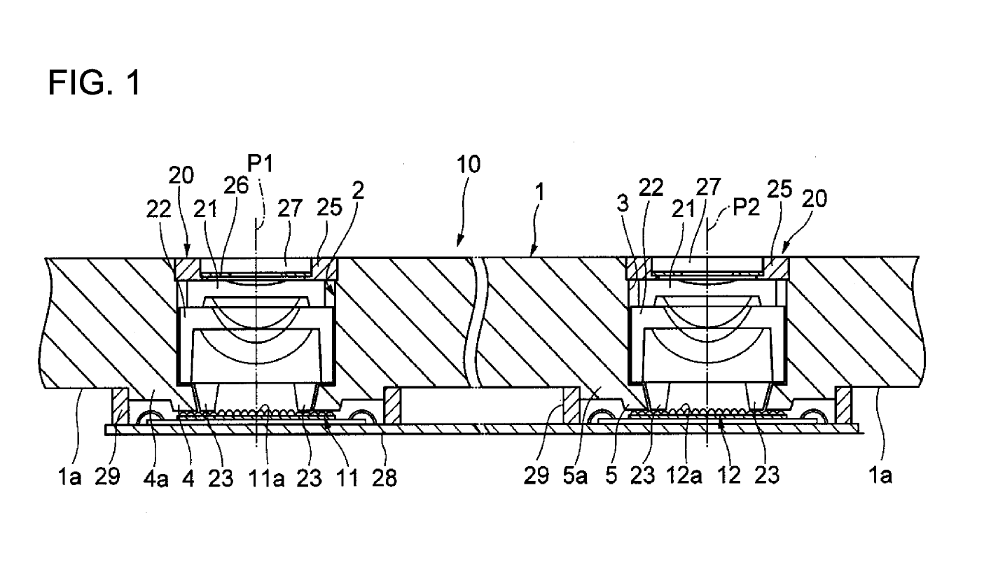

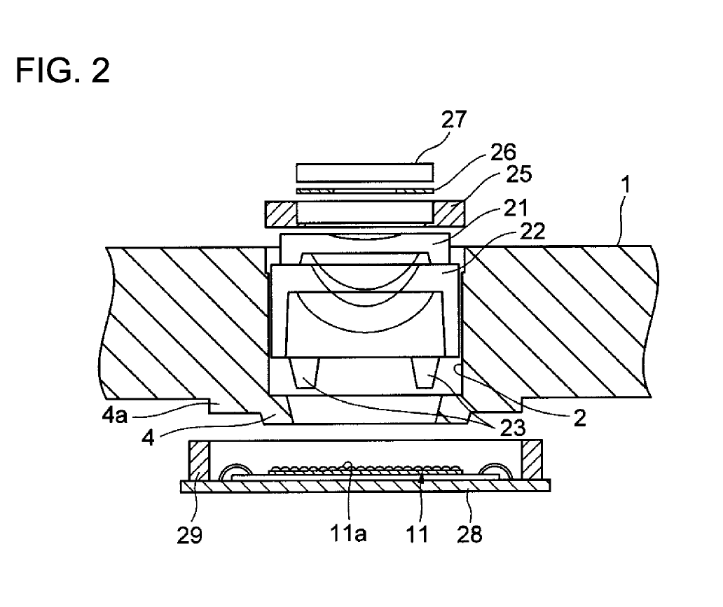

FIG. 1 is a cross sectional view of the main parts of an imaging device according to a first embodiment. FIG. 2 is an exploded cross sectional view of the main parts, which illustrates exploded parts of the imaging device in FIG. 1.

As shown in FIGS. 1 and 2, the imaging device 10 includes a first imaging element 11 that has an imaging surface 11a formed with many pixels, each of which has a photoelectric conversion function, a second imaging element 12 that has an imaging surface 12a formed with many pixels, each of which has a photoelectric conversion function, and a support 1 to which the imaging elements 11 and 12 are installed.

The imaging elements 11 and 12 are formed on a common board 28, each of which can be formed as a CCD, a CMOS image sensor, or the like. A micro lens is formed on each pixel of the imaging surface 11a and imaging surface 12a. In this application, “abutting on the imaging surface” means “abutting on the micro lens formed on the imaging surface” when the micro lens is formed and “abutting on the pixel surface” when the micro lens is not formed.

The support 1, which is a plate-like member, can be made of a metallic material such as aluminum or a resin material, enabling the imaging device 10 to be lightweight. The support 1 has installation holes 2 and 3, which are circular through-holes, in correspondence with the imaging devices 11 and 12, and steps 4a and 5a, which are projected from the lower surface 1a of the support 1, and also has steps 4 and 5, which are further projected from the lower surface 1a, near the installation holes 2 and 3.

An optical unit 20 is provided in each of the installation holes 2 and 3 formed in the support 1. The optical unit 20 has a lens unit, which is an optical system having a lens 21 and a lens 22, a lens pressing member 25, which is disposed above the lens 21 and presses the lens 21, a diaphragm member 26, and a cover member 27 made of glass. The lens 22 of the optical unit 20 has a supporting member 23 projected from the outer periphery of a flange member toward the imaging element 11 or 12.

Sealing members 29 are erected on the common board 28 so as to enclose the imaging elements 11 and 12.

Incident light from the cover member 27 shown in FIGS. 1 and 2 is brought to focus on the imaging surface 11a or 12a of the imaging element 11 or 12 by the optical system, which includes the lens 21 and lens 22. The light is then photoelectrically converted by many pixels, each of which has a photoelectric conversion function, on the imaging surface 11a or 12a, and output as an electric signal.

Assembling of the imaging device 10 in FIGS. 1 and 2 will be described. As shown in FIG. 1, the imaging elements 11 and 12 followed on the common board 28 are respectively disposed in the installation holes 2 and 3, and the sealing members 29 are installed to the lower surface 1a along the steps 4a and 5a of the support 1. Each sealing member 29 can be installed to the board 28 and lower surface 1a with, for example, an adhesive. The imaging elements 11 and 12 are internally sealed by the sealing members 29 and the board 28.

As described above, when the imaging elements 11 and 12 formed on the board 28 through the sealing members 29 are installed to the support 1, the projections 4 and 5 of the support 1 respectively abut on the imaging surfaces 11a and 12a of the imaging elements 11 and 12.

The optical units 20 are disposed in the installation holes 2 and 3 so that the lens 21 and lens 22 are pressed because the lens pressing member 25, which fixes the diaphragm member 26 and cover member 27, is fitted after the lens 22 and lens 21 are disposed as shown in FIG. 2. At that time, the supporting member 23 formed on the flange of the lens 22 of the optical unit 20 abuts on the outer periphery of the imaging surface 11a or 12a of the imaging element 11 or 12.

In the imaging device 10 assembled as described above, the optical units 20, each of which includes the lenses 21 and 22, are installed in the installation holes 2 and 3 formed in the support 1 so that the optical axes P1 and P2 of the optical units 20 respectively match the central lines of the circular installation holes 2 and 3, and the imaging elements 11 and 12 are installed to the support 1 so that the centers of the imaging surfaces 11a and 12a respectively match the optical axes P1 and P2.

According to the imaging device 10 as described above, the imaging elements 11 and 12 are respectively positioned in the directions of the optical axes P1 and P2 by having the imaging elements 11 and 12 respectively abutted on the projections 4 and 5 of the support 1 on the outer peripheries of their imaging surfaces 11a and 12a. Accordingly, only the support 1 is a member that interposes between the imaging surfaces 11a and 12a of the plurality of imaging elements 11 and 12, so the cumulative error between the imaging surfaces 11a and 12a of the plurality of imaging elements 11 and 12 can be minimized, making the imaging device highly precise.

Since each optical unit 20 is positioned in the direction of the optical axis P1 or P2 by having the supporting member 23 abutted on the outer periphery of the imaging surface 11a of the imaging element 11 or imaging surface 12a of the imaging element 12, the inclination of the optical axis of the optical unit 20 can be minimized. The interior of the imaging device 10 can be sealed by the sealing member 29 to prevent the entry of dust and other foreign materials.

It is preferable to have the projections 4 and 5 of the support 1 and the supporting member 23 abutted in a pixel area that is not used for an image in a photoelectric conversion area formed with a plurality of pixels, as shown in FIG. 2. However, the projections 4 and 5 may be abutted at positions outside the photoelectric conversion area on the imaging elements and the supporting member 23 may be abutted in a pixel area that is not used for an image in the photoelectric conversion area.

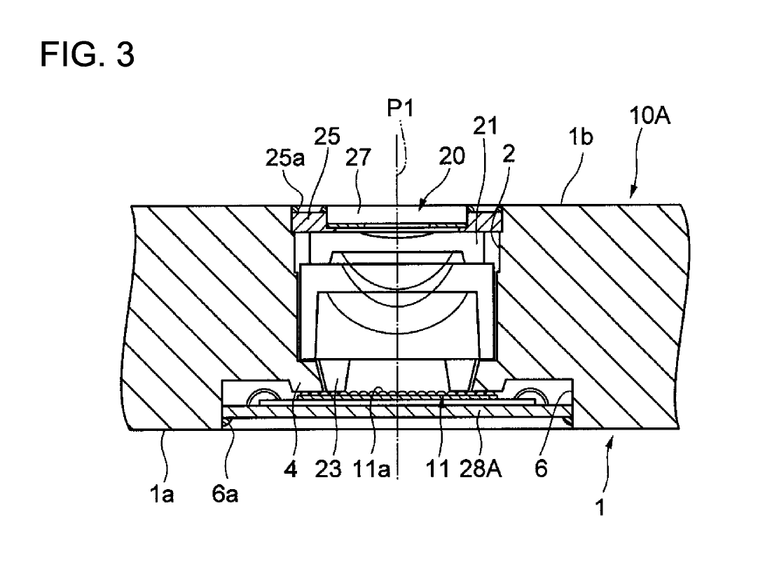

Next, a first variation of the imaging device shown in FIGS. 1 and 2 will be described with reference to FIG. 3. FIG. 3 is a cross sectional view of the main parts, which illustrates the first variation of the imaging device in FIGS. 1 and 2.

The imaging device 10A in FIG. 3 is structured so that the imaging element 11 is disposed in the support 1. That is, as shown in FIG. 3, a concave part 6, which communicates with the installation hole 2, is formed in the lower surface 1a of the support 1, the projection 4 on the support 1 is projected from the bottom surface of the concave part 6, the imaging element 11 is formed on an independent board 28A, and the board 28A is installed in such a way that it is fitted into the concave part 6. The projection 4 of the support 1 then abuts on the imaging surface 11a of the imaging element 11. The board 28A is installed to the concave part 6 of the support 1 with an adhesive 6a, sealing the interior of the concave part 6.

The optical unit 20 is disposed as in FIG. 1. Its supporting member 23 abuts on the outer periphery of the imaging surface 11a of the imaging element 11. The lens pressing member 25 is disposed at a position that is slightly below the upper surface 1b of the support 1 and sealed with an adhesive 25a.

The imaging element 12 in FIG. 1 is also installed in the installation hole 3 of the support 1 with the same structure as in FIG. 3.

As described above, according to the imaging device 10A, the imaging elements 11 and 12 are respectively positioned in the directions of the optical axes P1 and P2 by having the imaging elements 11 and 12 respectively abutted on the projections 4 and 5 of the support 1 on the outer peripheries of their imaging surfaces 11a and 12a. Accordingly, only the support 1 is a member that interposes between the imaging surfaces 11a and 12a of the plurality of imaging elements 11 and 12, so the cumulative error between the imaging surfaces 11a and 12a of the plurality of imaging elements 11 and 12 can be minimized, making the imaging device highly precise.

Since the board 28A integrated with the imaging element 11 and the optical unit 20 are accommodated in the support 1, the entire structure of the imaging device can be made compact. Furthermore, since the board 28A is installed with an adhesive and thereby the interior of the imaging device 10A can be sealed, the sealing member 29 in FIGS. 1 and 2 can be eliminated.

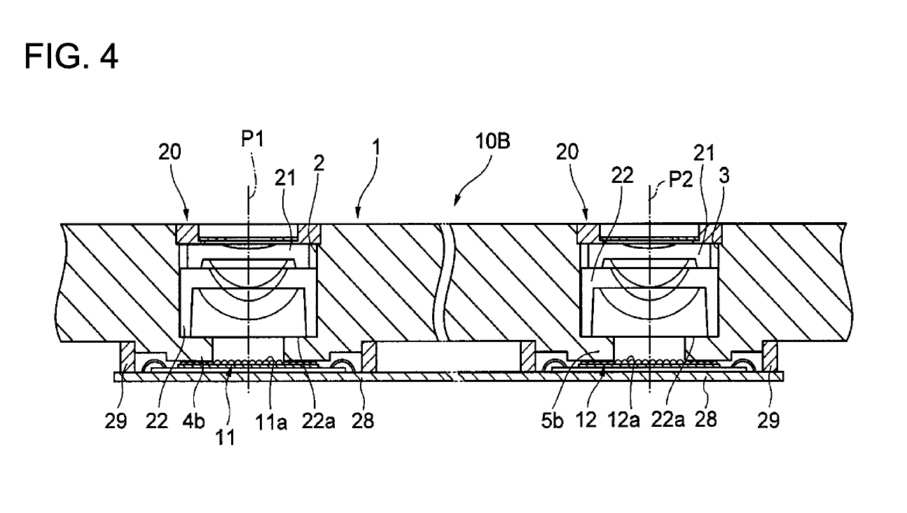

Next, a second variation of the imaging device shown in FIGS. 1 and 2 will be described with reference to FIG. 4. FIG. 4 is a cross sectional view of the main parts, which illustrates the second variation of the imaging device in FIGS. 1 and 2.

The imaging device 10B shown in FIG. 4 is arranged so that the bottom surface of the flange of the lens 22 of the optical unit 20 functions as the supporting member. That is, the projections 4b and 5b of the support 1 are slightly more projected horizontally toward the optical axes P1 and P2, respectively, than in FIGS. 1 to 3, the supporting member 23 (FIGS. 1 to 3) formed on the flange of the lens 22 of the optical unit 20 is eliminated, the lower surfaces of the projections 4b and 5b of the support 1 respectively abut on the imaging surfaces 11a and 12a of the imaging elements 11 and 12, and the upper surfaces of the projections 4b and 5b abut on their relevant bottom surface 22a of the flange formed on the lens 22 of their relevant optical unit 20.

According to the imaging device 10B as described above, the imaging elements 11 and 12 are respectively positioned in the directions of the optical axes P1 and P2 by having the imaging elements 11 and 12 respectively abutted on the projections 4b and 5b of the support 1 on the outer peripheries of their imaging surfaces 11a and 12a. Accordingly, the number of members that interpose between the imaging surfaces 11a and 12a of the plurality of imaging elements 11 and 12 can be minimized, so the cumulative error between the imaging surfaces 11a and 12a of the plurality of imaging elements 11 and 12 can be minimized, making the imaging device highly precise. A structure in which the bottom surface of the flange, which is part of the lens 22, as shown in FIG. 4 is abutted on the projections of the support 1 as the supporting member, may be applied to an imaging device as shown in FIG. 3.

According to this embodiment, since the plurality of imaging elements 11 and 12 are installed to the support 1 so that the support 1 abuts on the imaging surfaces 11a and 12a of the imaging elements 11 and 12, error in the mutual positional relation between the imaging elements 11 and 12 can be minimized and error in the installation positions of the imaging surfaces 11a and 12a can be minimized, and thereby an inexpensive, highly precise three-dimensional imaging device can be achieved with a simple structure. Accordingly, the rolls and pitches of the imaging surfaces 11a and 12a can be minimized. Although it is ideal that the optical axes P1 and P2 of the optical units 20 are mutually parallel, the supporting member of each optical unit 20 abuts on the imaging surface 11a or 12a and thereby the inclination of the optical axis of the optical unit 20 can be suppressed, making the optical unit 20 closer to the ideal state.

Since the number of members interposing between the imaging surfaces 11a and 12a of the imaging elements 11 and 12 is minimized, the number of person-hours and special circuits for adjustment between the imaging surfaces 11a and 12a become unnecessary and that adjustment also becomes unnecessary, so the number of person-hours required to assemble the imaging device can be minimized.

It is also possible to incorporate lenses that suit the application. In the case of stereovision for distance measurements or another purpose, for example, the focal distance of the optical system must be optimized according to the distance to a main subject. Since the imaging elements are common, however, only the lenses need to be changed while high precision is maintained, so an inexpensive camera formed with imaging elements can be provided.

In FIGS. 1 and 4, the board 28 is formed with a common member, but different boards may be used.

### Second Embodiment

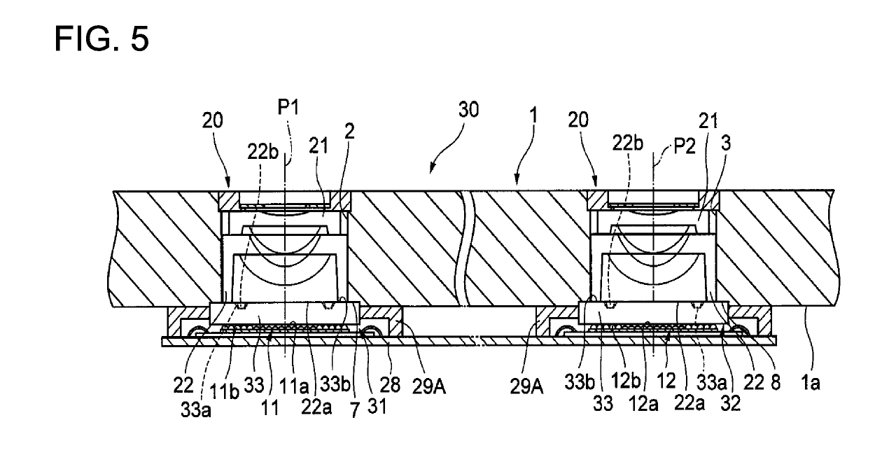

FIG. 5 is a cross sectional view of the main parts of an imaging device according to a second embodiment. In the imaging device 30 in FIG. 5, the optical units 20 described above are disposed in the installation holes 2 and 3, and imaging units 31 and 32 are respectively disposed in correspondence with the installation holes 2 and 3.

The imaging elements 11 and 12, which are formed on the common board 28, respectively have the imaging surfaces 11a and 12a formed with many pixels, each of which has a photoelectric conversion function, and spacers 11b and 12b, which are shaped like a micro lens and provided on the outer periphery sides of the imaging surfaces 11a and 12a, the thicknesses of the spacers being larger than the heights of micro lenses formed on the imaging surfaces 11a and 12a.

The imaging units 31 and 32 respectively have the imaging elements 11 and 12, and optical members 33 and 34, which are respectively abutted on the spacers 11b and 12b on the outer periphery side of the imaging surfaces 11a and 12a.

The optical unit 20 is structured as in FIGS. 1 and 2, except that it has a convex part 22b, which projects from the bottom surface 22a of the flange of the lens 22. A concave part 33a is formed in the optical member 33 of each of the imaging units 31 and 32, in correspondence with the convex part 22b.

On the support 1, steps 7 and 8, with a step height, extending from the lower surface 1a are respectively formed around the installation holes 2 and 3 so that the optical member 33 fits thereto.

Assembling of the imaging device 30 in FIG. 5 will be described. The imaging units 31 and 32 are respectively disposed in the installation holes 2 and 3 through a sealing member 29A and each optical member 33 is fitted to the step 7 or 8 of the support 1, so the upper surface 33b of the optical member 33 abuts on the step 7 or 8, the convex part 22b formed on the flange of the lens 22 enters the inside of the concave part 33a of the optical member 33, and the bottom surface 22a of the flange of the lens 22 abuts on the upper surface 33b of the optical member 33.

The sealing member 29A is abutted on the lower surface 1a of the support 1 and a side of the optical member 33 and installed with an adhesive, sealing the interior of the imaging unit 31 or 32. Although, in FIG. 5, the convex part 22b formed on the flange of the lens 22 and the concave part 33a of the optical member 33 have complementary shapes, which are substantially trapezoidal cross sections, they may have other shapes or may be omitted.

In the imaging device 30 assembled as described above, the optical units 20, each of which includes the lenses 21 and 22, are installed in the installation holes 2 and 3 formed in the support 1 so that the optical axes P1 and P2 of the optical units 20 respectively match the central lines of the circular installation holes 2 and 3, and the imaging elements 31 and 32 are installed to the support 1 so that the centers of the imaging surfaces 11a and 12a respectively match the optical axes P1 and P2.

As described above, according to the imaging device 30, the plurality of imaging units 31 and 32 are respectively positioned in the directions of the optical axes P1 and P2 by having the upper surface 33b of each optical member 33, which abuts on the spacer 11b or 12b of the imaging element 11 or 12, abutted on the step 7 or 8 of the support 1 as the supporting member. Accordingly, the number of members that interpose between the imaging surfaces 11a and 12a of the imaging elements 11 and 12 can be minimized, so the cumulative error between the imaging surfaces 11a and 12a of the imaging elements 11 and 12 can be minimized, making the imaging device highly precise.

Each optical unit 20 is also positioned in the direction of the optical axis P1 or P2 by having the bottom surface 22a, formed as the supporting member of the optical unit 20 on the flange of the lens 22, abutted on the upper surface 33b of the optical member 33 of the imaging unit 31 or 32. Accordingly, the inclination of the optical axis of the optical unit 20 can be minimized. The interior of the imaging device 30 can be sealed by the sealing member 29A to prevent the entry of dust and other foreign materials.

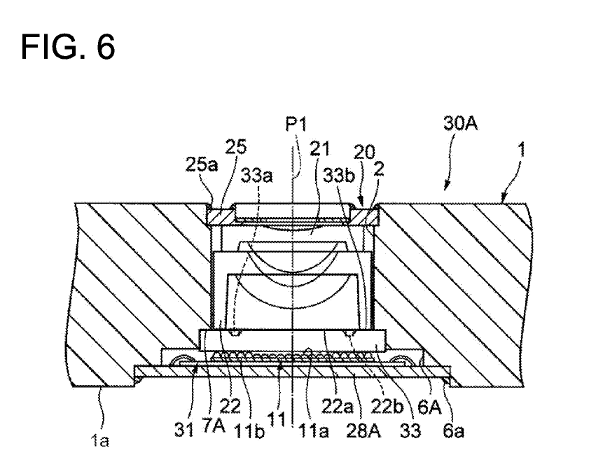

Next, a first variation of the imaging device shown in FIG. 5 will be described with reference to FIG. 6. FIG. 6 is a cross sectional view of the main parts, which illustrates the fast variation of the imaging device in FIG. 5.

The imaging device 30A in FIG. 6 is structured so that the imaging element 11 is disposed in the support 1. That is, as shown in FIG. 6, a concave part 6A, which communicates with the installation hole 2, is formed in the lower surface 1a of the support 1, a step 7A of the support 1 is formed on the bottom surface of the concave part 6A, the imaging element 11 is formed on an independent board 28A, and the imaging element 11 is installed in such a way that it is fitted into the concave part 6A. The step 7A of the support 1 then abuts on the upper surface 33b of the optical member 33 of the imaging unit 31. The board 28A is installed to the concave part of the support 1 with an adhesive 6a, sealing the interior of the concave part 6A.

The optical unit 20 is disposed as in FIG. 5. The bottom surface 22a formed on the flange of the lens 22 of the optical unit 20 abuts on the upper surface 33b of the optical member 33 of the imaging unit 31. The lens pressing member 25 is disposed at a position that is disposed slightly below the upper surface of the support 1 and sealed with an adhesive 25a.

The other imaging element 12 is also installed in the installation hole 3 of the support 1 with the same structure as in FIG. 6.

As described above, according to the imaging device 30A, the plurality of imaging units 31 and 32 are respectively positioned in the directions of the optical axes P1 and P2 by having the upper surfaces 33b of the optical members 33, which abut on the spacers 11b and 12b of the imaging elements 11 and 12, abutted on the steps 7A of the support 1 as the supporting members. Accordingly, the number of members that interpose between the imaging surfaces 11a and 12a of the imaging elements 11 and 12 can be minimized, so the cumulative error between the imaging surfaces 11a and 12a of the imaging elements 11 and 12 can be minimized, making the imaging device highly precise.

Each optical unit 20 is also positioned in the direction of the optical axis P1 or P2 by having the bottom surface 22a, formed as the supporting member of the optical unit 20 on the flange of the lens 22, abutted on the upper surface 33b of the optical member 33 of the imaging unit 31 or 32.

Since the imaging unit 31, which includes the imaging element 11, the board 28A, and the like, and the optical unit 20 are accommodated in the support 1, the entire structure of the imaging device can be made compact. Furthermore, since the board 28A is installed with an adhesive and thereby the interior of the imaging device 30A can be sealed, the sealing member 29A in FIG. 5 can be eliminated.

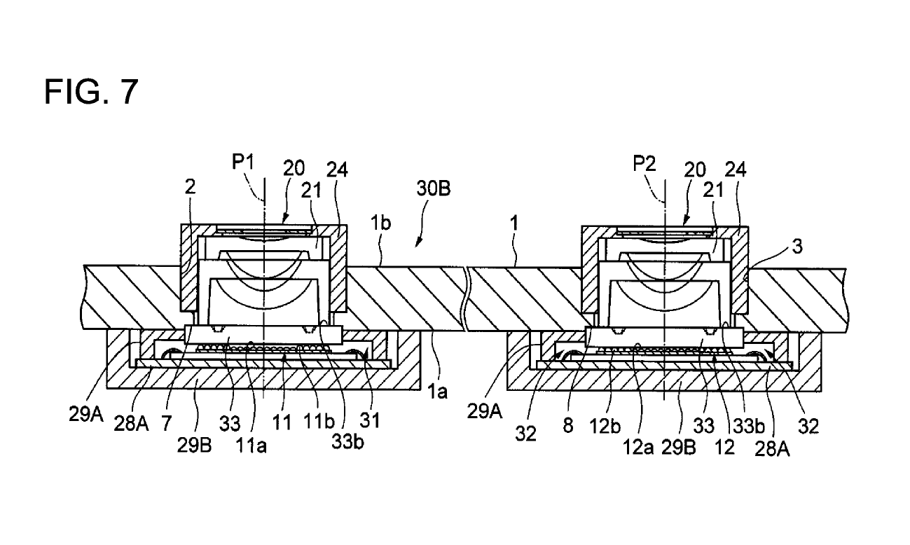

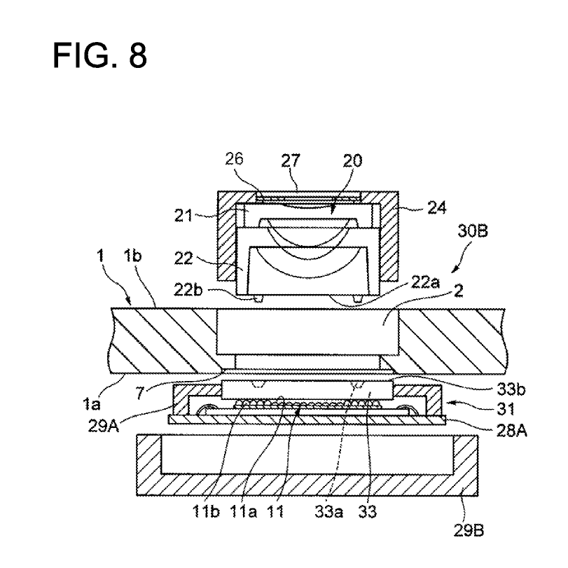

Next, a second variation of the imaging device shown in FIG. 5 will be described with reference to FIGS. 7 and 8. FIG. 7 is a cross sectional view of the main parts, which illustrates the second variation of the imaging device in FIG. 5. FIG. 8 is an exploded cross sectional view of the main parts, which illustrates exploded parts of the imaging device in FIG. 7.

The imaging device 3013 in FIGS. 7 and 8 is structured so that the optical units 20, each of which is integrated with a lens frame member 24, are installed in the installation holes 2 and 3 formed in the support 1, and the imaging units 31 and 32 are further sealed with a different sealing member 29A.

As shown in FIGS. 7 and 8, the imaging units 31 and 32 are each sealed by the board 28A, on which the imaging element 11 or 12 is formed, the sealing member 29A, and the optical member 33, and thereby the interior of each imaging unit is sealed.

The imaging units 31 and 32 are respectively disposed in the installation holes 2 and 3, the optical members 33 are fitted to the steps 7 and 8 on the support 1, and the upper surfaces 33b of the optical members 33 abut on the steps 7 and 8. Since the imaging units 31 and 32 are installed to the lower surface 1a of the support 1 by the different sealing members 29B, the interiors of the imaging units 31 and 32 are further sealed.

The members in each optical unit 20 are integrated by accommodating the lens 21 and lens 22 in the lens frame member 24, by having the lens 21 pressed by part of the lens frame member 24, and by disposing the diaphragm member 26 and cover member 27 on the lens 21 as seen in the drawing. The optical units 20 of this type are inserted into the installation holes 2 and 3 so as to be installed to the support 1. The bottom surface 22a formed on the flange of the lens 22 of the optical unit 20 then abuts on the upper surface 33b of the optical member 33 of the imaging unit 31 or 32.

As described above, according to the imaging device 30B, the plurality of imaging units 31 and 32 are positioned in the directions of the optical axes P1 and P2 by having the upper surfaces 33b of the optical members 33, which abut on the spacers 11b and 12b of the imaging elements 11 and 12, abutted on the steps 7 and 8 of the support 1 as the supporting members. Accordingly, the number of members that interpose between the imaging surfaces 11a and 12a of the imaging elements 11 and 12 can be minimized, so the cumulative error between the imaging surfaces 11a and 12a of the imaging elements 11 and 12 can be minimized, making the imaging device highly precise.

The optical unit 20 is also positioned in the directions of the optical axis P1 or P2 by having the bottom surface 22a, formed as the supporting member of the optical unit 20 on the flange of the lens 22, abutted on the upper surface 33b of the optical member 33 of the imaging unit 31 or 32. The interior of the imaging device 30 can be doubly sealed by the sealing members 29A and 29B to further prevent the entry of dust and other foreign materials.

Since, as shown in FIG. 7, each optical unit 20 integrated by the lens frame member 24 is installed so that it projects from the upper surface 1b of the support 1 and the imaging units 31 and 32 are installed so that they project to the lower surface 1a of the support 1, the thickness of the support 1 can be more reduced and thereby the imaging unit 30B, which includes the plurality of imaging units 31 and 32, can be made more lightweight.

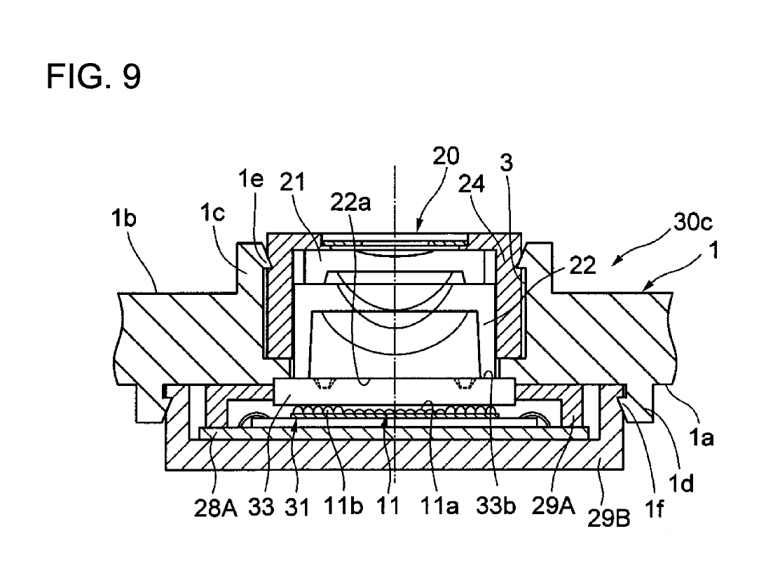

Next, a third variation of the imaging device shown in FIG. 5 will be described with reference to FIG. 9. FIG. 9 is a cross sectional view of the main parts, which illustrates the third variation of the imaging device in FIG. 5.

The imaging device 30C in FIG. 9 basically has the same structure as in FIGS. 7 and 8; a cylindrical part 1c projecting from the upper surface 1b of the support 1 concentrically with the instillation hole 3 is provided, and a claw 1e is provided on the inner surface of the cylindrical part 1c. The claw 1e engages the lens frame member 24 and the optical unit 20 is fixed to the support 1 when the lens frame member 24 of the optical unit 20 is inserted into the cylindrical part 1c and the installation hole 3.

Similarly, a cylindrical part 1d projecting from the lower surface 1a of the support 1 is provided, and a claw 1f is provided on the inner surface of the cylindrical part 1d. The claw 1f engages the sealing member 29B and the imaging unit 31 is fixed to the support 1 together with the sealing member 29B when the sealing member 29B is inserted into the cylindrical part 1d. The imaging unit 32 is also structured as described above.

According to the imaging device 30C in FIG. 9, the same effect as in FIGS. 7 and 8 is provided, and bonding of the sealing member 29B to the support 1 with an adhesive becomes unnecessary.

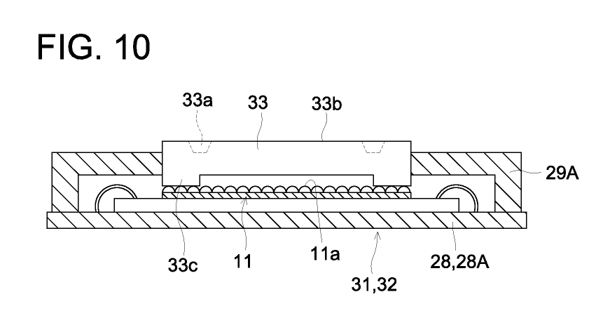

In FIGS. 5 to 9, the imaging units 31 and 32 may be structured as shown in FIG. 10. FIG. 10 is a cross sectional view of a side, which illustrates a variation of the imaging unit in FIGS. 5 to 9. As shown in FIG. 10, a projection 33c may be provided on the optical member 33, which downwardly projects from the outer periphery of the optical member 33, and the projection 33c may be disposed so as to strike a micro lens formed on the outer periphery of the imaging surface 11a of the imaging element 11. In this case, the spacer 11b in FIGS. 5 to 9 can be omitted.

According to the second embodiment described above, the same effect as in the first embodiment can be obtained. Although, in FIG. 5, the board 28 is formed with a common member, different boards may be used.

### Third Embodiment

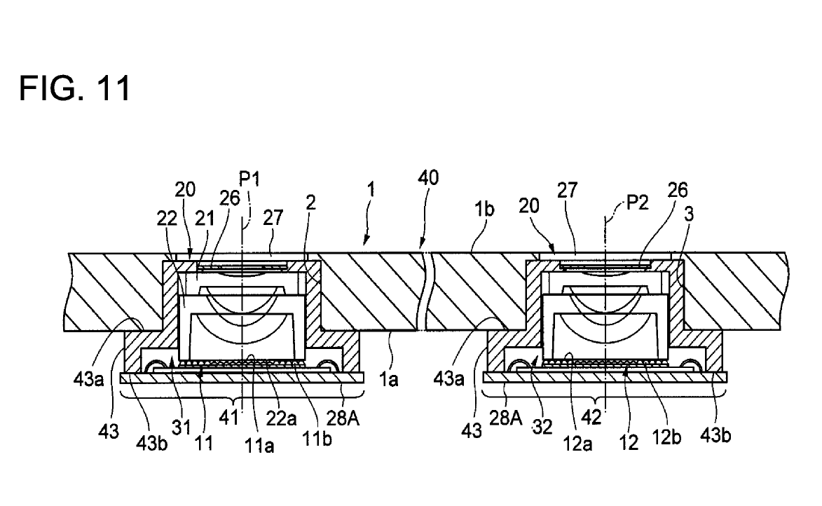

FIG. 11 is a cross sectional view of the main parts of an imaging device according to a third embodiment. In the imaging device 40 in FIG. 11, the optical units 20 and 20 and the imaging units 11 and 12, which are described above, are integrated with camera frame members 43 to form camera units 41 and 42, which are respectively installed in the installation holes 2 and 3 formed in the support 1.

The camera units 41 and 42 each have the optical unit 20, which includes the cover member 27 made of glass, diaphragm member 26, lens 21, and lens 22. The camera units 41 and 42 also respectively have the imaging elements 11 and 12 formed on the boards 28A and the camera frame members 43 fitted to the installation holes 2 and 3 in the support 1.

Many pixels, each of which has a photoelectric conversion function, are placed on the imaging surface 11a of the imaging element 11 and the imaging surface 12a of the imaging element 12. The spacers 11b and 12b are respectively placed outside the imaging surfaces 11a and 12a.

The lenses 21 and 22 are inserted into each camera frame member 43, and the diaphragm member 26 and cover member 27 are disposed above the lens 21. The board 28A, on which the imaging element 11 or 12 is formed, is disposed below the camera frame member 43.

In the camera units 41 and 42, the bottom surfaces 22a of the flanges formed on the lenses 22 of the relevant optical units 20 abut on the spacers 11b and 12b of the imaging elements 11 and 12. Each board 28A is bonded to the lower end 43b of the camera frame member 43 on its outer periphery with an adhesive or the like, and the interiors of the camera units 41 and 42 are sealed to prevent the entry of dust and other foreign materials. With the imaging elements 11 and 12 installed in this way, the centers of the imaging surfaces 11a and 12a respectively match the optical axes P1 and P2 of the optical units 20.

Assembling of the imaging device 40 in FIG. 11 will be described. Each camera frame member 43, in which the optical unit 20 and the imaging element 11 or 12 are disposed, is fitted into the installation hole 2 or 3. The plane part 43a of the camera frame members 43 is abutted on the lower surface 1a of the support 1.

In the imaging device 40 assembled as described above, the camera units 41 and 42 are installed in the installation holes 2 and 3 formed in the support 1 so that the optical axes P1 and P2 of the optical units 20, each of which includes the lenses 21 and 22, respectively match the central lines of the circular installation holes 2 and 3.

As described above, according to the imaging device 40, the plurality of camera units 41 and 42 are positioned in the directions of the optical axes P1 and P2 by having the camera units 41 and 42 abutted on the lower surface 1a of the support 1. Accordingly, the number of members that interpose between the imaging surfaces 11a and 12a of the imaging elements 11 and 12 can be minimized, so the cumulative error between the imaging surfaces 11a and 12a of the imaging elements 11 and 12 can be minimized, making the imaging device highly precise.

In the camera units 41 and 42, each optical unit 20 is also positioned in the direction of the optical axis P1 or P2 by having the bottom surface 22a, formed as the supporting member of the optical unit 20 on the flange of the lens 22, abutted on the spacer 11b or 12b of the imaging element 11 or 12. Accordingly, the inclination of the optical axis of the optical unit 20 can be minimized.

According to the third embodiment described above, the same effect as in the first embodiment can be obtained. Although, in FIG. 11, the boards 28A are formed with different members, a common board may be used.

The best mode for carryout the present invention has been described so far, but this is not a limitation to the present invention. Various variations are possible within the technical concept of the present invention. For example, although two-lens stereo cameras, in each of which two imaging elements are disposed, have been used in the embodiments, this is not a limitation to the present invention; it is apparent that the present invention can also be applied to multi-lens cameras, in which three or more imaging elements are disposed.

1-8. (canceled)

9. An imaging device comprising:
a plurality of imaging elements each having a plurality of pixels, each of which has a photoelectric conversion function; and
a support to which the plurality of imaging elements are installed,
wherein each of the plurality of imaging elements is positioned in an optical axial direction by coming in contact with the support.

10. The imaging device of claim 9, further comprising a plurality of optical units each having an optical system that forms an image on the imaging element,
wherein a supporting member that is in contact with the imaging element is formed on a part of the optical system, and the optical unit is positioned in the optical axial direction by bringing the supporting member into contact with the imaging element.

11. The imaging device of claim 9, further comprising a plurality of optical units each having an optical system that forms an image on the imaging element,
wherein a supporting member that is in contact with the support is formed on a part of the optical system, and the optical unit is positioned in the optical axial direction by bringing the supporting member into contact with the support.

12. The imaging device of claim 9, wherein an area of each of the plurality of imaging elements other than a photoelectric conversion area provided with the plurality of pixels, is in contact with the support.

13. The imaging device of claim 9, wherein a pixel area of each of the plurality of imaging elements that is not used for an image in a photoelectric conversion area formed with the plurality of pixels, is in contact with the support.

14. An imaging device comprising:
a plurality of imaging units each having an imaging element provided with a plurality of pixels each having a photoelectric conversion function, and an optical member that is in contact with the imaging element; and
a support to which the plurality of imaging elements are installed,
wherein each of the plurality of imaging units is positioned in an optical axial direction and is installed to the support by bringing the optical member of the imaging unit into contact with the support.

15. The imaging device of claim 14, further comprising a plurality of optical units each having an optical system in which an image is formed on the imaging element,
wherein a supporting member that is in contact with the optical member is formed on a part of the optical system, and the optical unit is positioned in the optical axial direction by bringing the supporting member into contact with the optical member.

16. An imaging device comprising:
(a) a plurality of camera units each having (1) an imaging element provided with a plurality of pixels each having a photoelectric conversion function; and (2) an optical unit having an optical system in which an image is formed on the imaging element,
wherein a supporting member that is in contact with the optical member is formed on a part of the optical system, and the optical unit is positioned in an optical axial direction by bringing the supporting member into contact with the optical member; and
(b) a support to which the plurality of camera units are installed,
wherein each of the plurality of camera units is positioned in the optical axial direction and is installed to the support by bringing each of the camera units into contact with the support.
